(19) United States
(12) Patent Application Publication
(10) Pub. No.: US 2025/0125405 A1
(43) Pub. Date: Apr. 17, 2025

(54) SOLID ELECTROLYTE FOR ALL SOLID-STATE BATTERY AND ALL SOLID-STATE BATTERY INCLUDING SAME

(71) Applicant: SAMSUNG SDI CO., LTD., Yongin-si (KR)

(72) Inventors: Gunwook LEE, Yongin-si (KR); Kyusung Park, Yongin-si (KR); Myoungki Min, Yongin-si (KR); Eungyeong Lee, Yongin-si (KR); Jaemin Kim, Yongin-si (KR); Sieun Lee, Yongin-si (KR); Inhyuk Son, Yongin-si (KR); Sungnim Jo, Yongin-si (KR); Kyueun Shim, Yongin-si (KR); Hyungsub Lim, Yongin-si (KR); Taehyun Park, Yongin-si (KR); Jieun Lee, Yongin-si (KR)

(21) Appl. No.: 18/666,101

(22) Filed: May 16, 2024

(30) Foreign Application Priority Data
Oct. 17, 2023 (KR) 10-2023-0138919

(51) Int. Cl. H01M 10/056; H01M 4/02; H01M 4/134; H01M 4/62

(52) U.S. Cl. CPC H01M 10/056; H01M 4/134; H01M 4/625; H01M 4/626; H01M 2004/027; H01M 2300/008

(57) ABSTRACT

A solid electrolyte for an all solid-state battery and an all solid-state battery including the solid electrolyte for an all solid-state battery, the solid electrolyte for an all solid-state battery includes an argyrodite-type compound; a sulfur-containing compound; and an iodine-containing compound, and the all solid-state battery includes a negative electrode; a positive electrode; and a solid electrolyte layer between the positive electrode and the negative electrode.

### CROSS-REFERENCE TO RELATED APPLICATION

This application claims priority to and the benefit of Korean Patent Application No. 10-2023-0138919 filed in the Korean Intellectual Property Office on Oct. 17, 2023, the entire contents of which are incorporated herein by reference.

### BACKGROUND

### 1. Field

Embodiments relate to a solid electrolyte for an all solid-state battery and an all solid-state electrolyte including the same.

### 2. Description of the Related Art

Recently, rapid development has been made in electronic devices using batteries, such as mobile phones, laptop computers, and electric vehicles.

As such a battery, the development for an all solid-state battery has been progressed. An all solid-state battery refers to a battery in which all materials are solid, e.g., a battery using a solid electrolyte. The all solid-state battery may be structurally strong because an electrolyte is solid, and thus, there may be a low risk of fire or explosion caused the electrolyte leakage due to external impact, or the like. The all solid-state battery may be formed in various shapes, and thus, it may useful in variety applications.

### SUMMARY

The embodiments may be realized by providing a solid electrolyte for an all solid-state battery, the solid electrolyte including an argyrodite-type compound; a sulfur-containing compound; and an iodine-containing compound.

The sulfur-containing compound may include Li₂S.

The iodine-containing compound may include LiI.

A mixing ratio of the sulfur-containing compound and the iodine-containing compound may be about 1:9 to about 9:1 by weight.

The sulfur-containing compound and the iodine-containing compound may be a solid solution in the solid electrolyte.

The solid solution may have a particle diameter of about 5 μm or less.

The solid solution may have a particle diameter of about 0.1 μm to about 5 μm.

An amount of the solid solution may be about 1 wt % to about 30 wt %, based on a total weight of the solid electrolyte.

An amount of the argyrodite-type compound may be about 70 wt % to about 99 wt %, based on a total weight of the solid electrolyte.

The argyrodite-type compound may include a sulfide compound.

The argyrodite-type compound may include LiₐM_{b}P_{c}S_{d}Aₑ, in which a, b, c, d and e are all 0 or more and 12 or less, M is Ge, Sn, Si, or a combination thereof, and A is F, Cl, Br, or I.

The argyrodite-type compound may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P (S_{4.70}SO_{40.05})Cl_{1.25}, (Li_{5.69}Cu_{0.06})P (S_{4.60} SO_{40.15})Cl_{1.25}, (Li_{5.72}Cu_{0.03})P (S_{4.725} SO_{40.025})Cl_{1.25}, (Li_{5.72}Na_{0.03})P (S_{4.725} SO_{40.025})Cl_{1.25}, Li_{5.75}P (S_{4.725} SO_{40.025})Cl_{1.25}, or a combination thereof.

The embodiments may be realized by providing an all solid-state battery including a negative electrode; a positive electrode; and a solid electrolyte layer between the positive electrode and the negative electrode, the solid electrolyte layer including the solid electrolyte according to an embodiment.

The solid electrolyte layer may further include a binder.

The negative electrode may include a metal and a carbon material.

The metal may include Ag, Zn, Al, Sn, Mg, Ge, Cu, In, Ni, Bi, Au, Si, Pt, Pd, or a combination thereof.

The carbon material may include crystalline carbon, amorphous carbon, or a combination thereof.

### BRIEF DESCRIPTION OF THE DRAWINGS

Features will be apparent to those of skill in the art by describing in detail exemplary embodiments with reference to the attached drawings in which:

FIG. 1 is a schematic view schematically showing an all-solid-state battery according to some embodiments.

FIG. 2 is a schematic view schematically showing an all-solid-state battery according to another embodiment.

FIG. 3 is a graph showing the cycle-life characteristic of the all solid-state cells according to Example 1, and Comparative Examples 1 and 2.

FIG. 4 is a graph showing the fast charging and discharge characteristics of the all solid-state cell according to Example 1.

FIG. 5 is a graph showing the fast charging and discharge characteristics of the all solid-state cell according to Comparative Example 1.

FIG. 6 is a graph showing the fast charging and discharge characteristics of the all solid-state cell according to Comparative Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that when a layer is referred to as being “between” two layers, it can be the only layer between the two layers, or one or more intervening layers may also be present. Like reference numerals refer to like elements throughout.

Terms used in the specification is used to explain embodiments, but are not intended to be limiting. Expressions in the singular include expressions in plural unless the context clearly dictates otherwise.

The term “combination thereof may include a mixture, a laminate, a complex, a copolymer, an alloy, a blend, a reactant of constituents.

The terms “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

Throughout the specification of the present disclosure, when it is said that a constituent component “includes” a certain component, this means that it does not exclude other components but may further include other components, unless specifically stated to the contrary.

The terms “about,” “substantially,” etc. used throughout the specification herein are used in the sense of being at or close to that value when manufacturing and material tolerances inherent in the stated meaning are presented and are used to prevent unscrupulous infringers from taking unfair advantage of disclosures in which precise or absolute figures are mentioned so as to aid understanding of the present disclosure.

Throughout this specification, the description of “A and/or B” and “A or B” are not exclusive terms, and mean “A or B or both”.

As used herein, when specific definition is not otherwise provided, It will be understood that when an element such as a layer, film, region, or substrate is referred to as being “on” another element, it can be directly on the other element or intervening elements may also be present.

In the present invention, “particle size” or “particle diameter” may be an average particle size. The average particle size may be defined as the average particle size (D50) based on 50% of the cumulative volume in the cumulative size-distribution curve. The particle diameter can be measured by methods well known to those skilled in the art, for example, by measuring with a particle size analyzer, a transmission electron microscope or scanning electron microscope, a scanning electron microscope or field emission scanning electron microscopy (FE-SEM). In some embodiments, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated. The average particle diameter may be taken the diameter (D50) of the particles with a cumulative volume of 50 volume % as the average particle diameter from a particle size distribution which is obtained by randomly measuring the size (diameter or length of long axis) of approximately 20 particles in the scanning electron microscope image.

“Thickness” may be measured through a picture taken with an optical microscope such as a scanning electron microscope.

One or more embodiments may provide a solid electrolyte for an all solid-state battery including an argyrodite-type compound, a sulfur-containing compound; and an iodine-containing compound.

Whether the solid electrolyte includes a sulfur-containing compound and an iodine-containing compound may be confirmed by suitable procedures, e.g., EDS (Energy Dispersive Spectrometer) analysis.

In an implementation, the sulfur-containing compound may be Li₂S. In an implementation, the iodine-containing compound may be LiI. Hereinafter, the description will be made based on the sulfur-containing compound being Li₂S and the iodine-containing compound being LiI.

In the solid electrolyte according to one or more embodiments, Li₂S and LiI may exist as or be a solid solution. In an implementation, the solid electrolyte may include a solid solution of Li₂S and LiI. In an implementation, the solid electrolyte may include Li₂S and LiI, e.g., a solid solution of Li₂S and LiI, and internal pores of the solid electrolyte may be reduced. This may help improve durability of the solid electrolyte. In an implementation, the improvement in the durability of the solid electrolyte may indicate improvement of short-circuit characteristics, and thus, any short-circuiting does not occur even if a high-rate charge is performed. In an implementation, the all solid-state battery including the solid electrolyte may able to be fast charged. These effects may be not suitably obtained, if the solid electrolyte were to only include Li₂S or LiI.

Whether the solid electrolyte includes the solid solution may be confirmed by suitable procedures, e.g., EDS (Energy Dispersive Spectrometer) analysis. In an implementation, if S and I are detected together in a specific region through SEM-EDS analysis, it may be considered that the solid solution exists.

In an implementation, a mixing ratio of Li₂S and LiI may be a weight ratio of, e.g., about 1:9 to about 9:1, a weight ratio of about 2:8 to about 8:2, a weight ratio of about 3:7 to about 7:3, or a weight ratio of about 4:6 to about 6:4. Maintaining the mixing ratio of Li₂S and LiI within the above ranges may help ensure that the durability of the solid electrolyte layer including the solid electrolyte may be improved.

In an implementation, a particle diameter of the solid solution may be, e.g., about 5 μm or less, about 0.1 μm to about 5 μm, about 0.5 μm to about 5 μm, about 0.5 μm to about 4 μm, about 0.5 μm to about 3 μm, about 0.5 μm to about 2 μm, or about 0.5 μm to about 1 μm. Maintaining the particle diameter of the solid solution within the ranges may help ensure that the solid electrolyte layer may be readily prepared and the solid electrolyte layer with a higher filling rate may be prepared.

The solid solution may have a larger volume compared to the particle size of the argyrodite-type compound. In an implementation, the solid solution may be located between (e.g., particles of) the argyrodite-type compound, and the internal pores of the solid electrolyte may be effectively reduced.

In an implementation, an amount of the Li₂S and LiI, e.g., an amount of the solid solution may be about 1 wt % to about 30 wt %, about 1 wt % to about 10 wt %, or about 5 wt % to about 10 wt %, based on a total weight of the solid electrolyte. Maintaining the amount of the solid solution within the ranges may help ensure that the internal pores may be effectively reduced.

In an implementation, an amount of the argyrodite-type compound may be about 70 wt % to about 99 wt %, about 90 wt % to about 99 wt %, or about 90 wt % to about 95 wt %, based on the total weight of the solid electrolyte. Maintaining the amount of the solid solution within the ranges may help ensure that the internal pores may be effectively reduced.

In an implementation, the argyrodite-type compound may be a sulfide compound, e.g., LiₐM_{b}P_{c}S_{d}Aₑ (in which a, b, c, d and e are all about 0 or more and about 12 or less, M is Ge, Sn, Si, or a combination thereof, and A is F, Cl, Br, or I).

In an implementation, the argyrodite-type compound may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P (S_{4.70} SO_{40.05})Cl_{1.25}, (Li_{5.69}Cu_{0.06})P (S_{4.60} SO_{40.15})Cl_{1.25}, (Li_{5.72}Cu_{0.03})P (S_{4.725} SO_{40.025})Cl_{1.25}, (Li_{5.72}Na_{0.03})P (S_{4.725} SO_{40.025})Cl_{1.25}, Li_{5.75}P (S_{4.725} SO_{40.025}) Cl_{1.25}, or a combination thereof.

In an implementation, the argyrodite-type compound may include, e.g., Li₆PS₅Cl, Li_{5.8}PS_{4.8}Cl_{1.2}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P (S_{4.70}SO_{40.05})Cl_{1.25}, (Li_{5.69}Cu_{0.06})P (S_{4.60} SO_{40.15})Cl_{1.25}, (Li_{5.72}Cu_{0.03})P (S_{4.725} SO_{40.025})Cl_{1.25}, (Li_{5.72}Na_{0.03})P (S_{4.725} SO_{40.025}) Cl_{1.25}, Li_{5.75}P (S_{4.725} SO_{40.025}) Cl_{1.25}, or a combination thereof.

A particle diameter of the argyrodite-type compound may be about 0.5 μm to about 10 μm, or about 1 μm to about 10 μm. Maintaining the particle diameter of the argyrodite-type compound within the ranges may help ensure that suitable ionic conductivity and excellent cycle-life characteristic may be exhibited.

In the solid electrolyte according to one or more embodiments, a weight ratio (e.g., wt %) of the argyrodite-type compound, Li₂S, and LiI may be confirmed by converting the area conversion ratio to a weight ratio via a SEM-EDS analysis. Hereinafter, one example of confirming the weight ratio by converting the area conversion ratio to weight ratio will be described.

Table 1 shows one example of the specific gravity of the argyrodite-type compound, Li₂S, LiI, and a solid solution of Li₂S—LiI.

TABLE 1

| compound | Specific gravity (g/ml) |
|---|---|
| Argyrodite-type compound | 0.7 |
| Li₂S | 1.6 |
| LiI | 3.5 |
| Li₂S-LiI solid solution (weight ratio 2:3) | 2.74 |
| Li₂S-LiI solid solution (weight ratio 3:2) | 2.36 |
| Li₂S-LiI solid solution (weight ratio 1:2) | 2.87 |
| Li₂S-LiI solid solution (weight ratio 2:1) | 2.23 |
| Li₂S-LiI solid solution (weight ratio 1:1) | 2.55 |

Table 2 shows the area convention ratio and the volume conversion ratio according to the weight ratio of the argyrodite-type compound and a Li₂S—LiI solid solution, considering the above Table 1.

TABLE 2

| | | | Volume | Area |
|---|---|---|---|---|
| | | Weight | conversion | conversion |
| Division | Mixture | ratio | ratio | ratio |
| SpL 1-1 | Argyrodite-type compound | 90.0% | 97.2% | 91.5% |
| | Li₂S-LiI solid solution | 10.0% | 2.8% | 8.5% |
| | (weight ratio 2:3) | | | |
| SpL 1-2 | Argyrodite-type compound | 92.0% | 97.8% | 92.7% |
| | Li₂S-LiI solid solution | 8.0% | 2.2% | 7.3% |
| | (weight ratio 2:3) | | | |
| SpL 1-3 | Argyrodite-type compound | 94.0% | 98.4% | 94.0% |
| | Li₂S-LiI solid solution | 6.0% | 1.6% | 6.0% |
| | (weight ratio 2:3) | | | |
| SpL 1-4 | Argyrodite-type compound | 96.0% | 98.9% | 95.4% |
| | Li₂S-LiI solid solution | 4.0% | 1.1% | 4.6% |
| | (weight ratio 2:3) | | | |
| SpL 1-5 | Argyrodite-type compound | 98.0% | 99.5% | 97.1% |
| | Li₂S-LiI solid solution | 2.0% | 0.5% | 2.9% |
| | (weight ratio 2:3) | | | |
| SpL 2 | Argyrodite-type compound | 90.0% | 96.8% | 90.7% |
| | Li₂S-LiI solid solution | 10.0% | 3.2% | 9.3% |
| | (weight ratio 3:2) | | | |
| SpL 3 | Argyrodite-type compound | 90.0% | 97.4% | 91.7% |
| | Li₂S-LiI solid solution | 10.0% | 2.6% | 8.3% |
| | (weight ratio 1:2) | | | |
| SpL 4 | Argyrodite-type compound | 90.0% | 96.6% | 90.4% |
| | Li₂S-LiI solid solution | 10.0% | 3.4% | 9.6% |
| | (weight ratio 2:1) | | | |
| SpL 5 | Argyrodite-type compound | 90.0% | 97.0% | 91.1% |
| | Li₂S-LiI solid solution | 10.0% | 3.0% | 8.9% |
| | (weight ratio 1:1) | | | |

In an implementation, in case of SpL 1-1, the area ratio of the argyrodite-type compound and the Li₂S—LiI solid solution were respectively analyzed as about 91.5% and about 8.5% on the SEM-EDS image, and the weight ratio may be regarded as about 90.0% and about 10.0%.

This conversion method is illustrated and the weight ratio may be calculated in a different way.

### <Preparation of Solid Electrolyte>

Li₂S may be mixed with LiI. A mixing ratio of Li₂S and LiI may be a weight ratio of about 1:9 to about 9:1, a weight ratio of about 2:8 to about 8:2, a weight ratio of about 3:7 to about 7:3, or a weight ratio of about 4:6 to about 6:4. The mixture may be subjected to a ball milling to prepare a solid solution. The ball milling process may be performed for about 5 hours to 15 hours, or about 7 hours to about 10 hours. A particle diameter of the solid solution may be about 5 μm, about 0.1 μm to about 5 μm, about 0.5 μm to about 5 μm, about 0.5 μm to about 4 μm, about 0.5 μm to about 3 μm, about 0.5 μm to about 2 μm, or about 0.5 μm to about 1 μm.

The solid solution may be mixed with an argyrodite-type compound to prepare a solid electrolyte. An amount of the solid solution may be about 1 wt % to about 30 wt %, about 1 wt % to about 10 wt %, or about 5 wt % to about 10 wt %, based on the total weight of the solid electrolyte.

The configuration of the solid electrolyte layer will be described below.

### <Solid Electrolyte Layer>

The solid electrolyte layer may include the solid electrolyte according to one or more embodiments.

The solid electrolyte layer may further a binder. The binder may include a styrene butadiene rubber, polytetrafluoroethylene, polyvinylidene fluoride, polyethylene, an acrylate polymer, an acryl rubber, or a combination thereof, or other suitable binder. The acrylate polymer may include butyl acrylate, polyacrylate, polymethacrylate, or a combination thereof.

The solid electrolyte according to one or more embodiments may include an argyrodite-type compound, and Li₂S and LiI, e.g., a solid solution of Li₂S and LiI. The solid solution may have a larger volume compared to the particle size of the argyrodite-type compound. In an implementation, the solid solution may be located between the argyrodite-type compounds, and it may help reduce the internal pores of the solid electrolyte. In an implementation, the solid electrolyte may be used to prepare a solid electrolyte layer, and a solid electrolyte layer in which the internal pores are significantly reduced may be prepared. In an implementation, it may include Li₂S and LiI, e.g., the solid solution of Li₂S and LiI, and the adhesion with the binder may be excellent. The solid electrolyte layer including the solid electrolyte according to one or more embodiments may exhibit excellent durability.

The solid electrolyte layer may be prepared by adding the solid electrolyte according to one or more embodiments to a binder solution, coating the resultant on a substrate film, and drying it. A solvent of the binder solution may include, e.g., isobutyryl isobutyrate, xylene, toluene, benzene, hexane, butyl butyrate, isobutyl isobutyrate, tetrahydrofuran, 2-methylbutyl butyrate, hexyl butyrate, benzyl butyrate, benzyl isobutyrate, isopentyl butyrate, octyl acetate, or a combination thereof.

The solid electrolyte layer may have a thickness, e.g., about 10 μm to about 150 μm.

In an implementation, the solid electrolyte layer may further include, e.g., an alkali metal salt, an ionic liquid, or a conductive polymer.

The alkali metal salt may be, e.g., a lithium salt. In the solid electrolyte layer, a concentration of the lithium salt may be about 1 M or more, e.g., about 1 M to about 4 M. In this case, the lithium salt may help improve the lithium ion mobility of the solid electrolyte layer, thereby improving ionic conductivity.

The lithium salt, may be, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃ C₂F₅, lithium bis(oxalato) borate, LiBOB), lithium oxalyldifluoroborate (LIODFB), lithium difluoro (oxalato) borate, LiDFOB), lithium bis(trifluoro methanesulfonyl)imide, LiTFSI, LiN (SO₂CF₃)₂), lithium bis(fluorosulfonyl)imide (lithium bis(fluorosulfonyl)imide, LiFSI, LiN (SO₂F)₂), LiCF₃SO₃, LiAsF₆, LiSbF₆, LiClO₄ or a mixture thereof.

The lithium salt may include an imide lithium salt, e.g., lithium bis(trifluoro methanesulfonyl)imide (LiTFSI, LiN (SO₂CF₃)₂), or lithium bis(fluorosulfonyl)imide (LiFSI, or LiN (SO₂F)₂). The lithium salt may suitably maintain the chemical reactivity with the ionic liquid, and thus, the ionic conductivity may be maintained or improved.

The ionic liquid may have a melting point of a room temperature or less which may be a liquid state at a room temperature and salts consisting of only ion, or a room-temperature molten salt.

The ionic liquid may be a compound including a cation, e.g., ammonium, pyrrolidinium, pyridinium, pyrrimidinium, imidazolium, piperridinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻.

The ionic liquid may include, e.g., N-methyl-N-propylpyrroledinium bis(trifluoromethanesulfonyl)imide, N-butyl-N-methylpyrroleridium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

In the solid electrolyte layer, a weight ratio of the solid electrolyte and the ionic liquid may be about 0.1:99.9 to about 90:10, e.g., about 10:90 to about 90:10, about 20:80 to about 90:10, about 30:70 to about 90:10, about 40:60 to about 90:10, or about 50:50 to about 90:10. Within the ranges, the solid electrolyte may have an improved electrochemical contact area to the electrode, and thus, the ionic conductivity may be maintained or improved. This may help improve the energy density, discharge capacity, rate capability, or the like of the all solid-state battery.

### All Solid-State Battery

Another embodiment may provide an all solid-state battery including the solid electrolyte. The all solid-state battery may include a positive electrode, a negative electrode, and a solid electrolyte layer between the positive electrode and the negative electrode. The solid electrolyte layer may include the solid electrolyte according to one or more embodiments.

### <Positive Electrode>

The positive electrode may include a positive current collector and a positive electrode active material layer on the positive current collector.

The positive electrode active material layer may include a positive electrode active material. The positive electrode active material may include compounds that reversibly intercalate and deintercalate lithium ions. In an implementation, the positive electrode active material may include a composite oxide of a metal, e.g., cobalt, manganese, nickel, or a combination thereof, and lithium. In an implementation, the positive electrode active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤05); LiₐNi_{1-b-c}Co_{b}B¹_{c}D¹_{α} (0.90≤a≤1.8, 0≤b≤0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); or LiFePO₄.

In the chemical formulas, A may be, e.g., Ni, Co, Mn, or a combination thereof; B¹ may be, e.g., Al, Ni, Co, Mn, Cr, Fe, Mg, Sr, V, a rare earth element, or a combination thereof; D¹ may be, e.g., O, F, S, P, or combination thereof; E may be, e.g., Co, Mn, or combination thereof; F¹ may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; I¹ may be, e.g., Cr, V, Fe, Sc, Y, or a combination thereof; J may be, e.g., V, Cr, Mn, Co, Ni, Cu, or a combination thereof; L¹ may be, e.g., Mn, Al, or a combination thereof.

In an implementation, the positive electrode active material may be a three-component (e.g., three components other than lithium and oxygen) lithium transition metal oxide, e.g., LiNiₓCo_{y}Al_{z}O₂ (NCA), LiNixCoyMnzO2 (NCM) (where, 0<x<1, 0<y<1, 0<z<1, x+y+z=1) (wherein, 0<x<1, 0<y<1, 0<z<1, x+y+z=1), or the like.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be provided by a method having no (or substantially no) adverse influence on properties of a positive electrode active material by using these elements in the compound. In an implementation, the method may include a suitable coating method, e.g., spray coating, dipping, or the like.

In an implementation, the coating layer may include suitable coating materials for the positive electrode active material of an all solid battery. In an implementation, it may be a buffer layer which serves to reduce an interface resistance of the positive electrode active material and the solid electrolyte. In an implementation, the buffer layer may include lithium-metal-oxide and this metal may include, e.g., Al, B, Ca, Ce, Cr, Fe, Mg, Mo, Nb, Si, Sn, Sr, Ta, V, W, or Zr. In an implementation, the buffer layer may be, e.g., Li₂O—ZrO₂ (LZO), LiNbO₂, or the like.

In an implementation, the positive electrode active material may include three-components including nickel, cobalt, and manganese, or nickel, cobalt, and aluminum, the capacity density of the all solid-state battery may be further improved, and the metal elution from the positive electrode active material at charged state may be further reduced. This may help further improve long reliability and cycle characteristics of the all solid-state battery at charged state.

The average particle diameter of the positive electrode active material may be about 1 μm to 25 μm, e.g., 3 μm to 25 μm, 1 μm to 20 μm, 1 μm to 18 μm, 3 μm to 15 μm, or 5 μm to 15 μm. In an implementation, the positive electrode active material may include small particles with an average particle diameter D50 of about 1 μm to about 9 μm and large particles with an average particle diameter D50 of about 10 μm to about 25 μm. The positive electrode active material with the above particle diameter ranges may be harmoniously mixed with other components in the positive electrode active material layer and may achieve high capacity and high energy density.

The positive electrode active material may be secondary particle where a plurality of primary particles is agglomerated, or monocrystalline (single crystal). The shape of the positive electrode active material may be, e.g., a spherical shape, a shape close to spherical, or a particle shape such as polyhedron, or unspecified shape, or the like.

In the positive electrode active material layer, an amount of the positive electrode active material may be a suitable amount which may be applied to a positive electrode layer of the conventional all solid-state secondary battery. In an implementation, based on the total weight of the positive electrode active material layer, the positive electrode active material may be included at about 55 wt % to about 99.5 wt %, for example, about 65 wt % to about 95 wt %, or about 75 wt % to about 91 wt %.

The positive electrode active material layer may further include a binder or a conductive material.

The binder may include, e.g., polyvinyl alcohol, carboxymethyl cellulose, hydroxypropyl cellulose, diacetyl cellulose, polyvinylchloride, carboxylated polyvinylchloride, polyvinyl fluoride, polyethylene oxide, polyvinylpyrrolidone, polyurethane, polytetrafluoroethylene, polyvinylidene fluoride, polyvinylidene fluoride-hexafluoropropylene, polyethylene, polypropylene, a styrene-butadiene rubber, an acrylated styrene-butadiene rubber, an epoxy resin, nylon, or the like.

The binder may be included in an amount of about 0.1 wt % to about 5 wt %, or about 0.1 wt % to about 3 wt %, based on the total weight of the positive electrode active material layer. Within these ranges of amounts, the adhesion ability may be sufficiently secured without deteriorating the battery performance.

The conductive material may be included to provide electrode conductivity. A suitable electrically conductive material that does not cause a chemical change may be used. Examples of the conductive material may include a carbon material such as natural graphite, artificial graphite, carbon black, acetylene black, ketjen black, carbon fiber, carbon nanofiber, carbon nanotube and the like; a metal material of a metal powder or a metal fiber including; copper, nickel, aluminum, silver, and the like; a conductive polymer such as polyphenylene derivatives; or mixtures thereof.

The conductive material may be included in an amount of about 0.1 wt % to about 5 wt %, or about 0.1 wt % to about 3 wt %, based on the total weight of the positive electrode active material layer. Maintaining the amount of the conductive material in the above amount ranges may help improve the electrical conductivity without deteriorating battery performance.

The positive electrode active material layer may further include solid electrolyte. The solid electrolyte included in the positive electrode active material layer may be an inorganic solid electrolyte such as a sulfide solid electrolyte, an oxide solid electrolyte, a halide solid electrolyte, or the like, or a solid polymer electrolyte. The solid electrolyte may be the same as described in the solid electrolyte above, and may be the same to or different from the solid electrolyte included in the solid electrolyte layer.

Based on the total weight of the positive electrode active material layer, the solid electrolyte may be included at an amount of about 0.1 wt % about to 35 wt %, e.g., about 1 wt % to about 35 wt %, about 5 wt % to about 30 wt %, about 8 wt % to about 25 wt %, or about 10 wt % to about 20 wt %. In the positive electrode active material layer, based on the total weight of the positive electrode active material and the solid electrolyte, the positive electrode active material of about 65 wt % to about 99 wt % and the solid electrolyte of about 1 wt % to about 35 wt % may be included, e.g., the positive electrode active material of about 80 wt % to about 90 wt % and the solid electrolyte of about 10 wt % to about 20 wt % may be included. Maintaining the amount of the solid electrolyte within the above ranges may help ensure that the efficiency and cycle-life characteristic of the all solid-state battery may be improved, without deterioration of capacity.

The positive current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

### <Negative Electrode>

The negative electrode according to one or more embodiments may include a current collector and a negative electrode coating layer on the current collector.

In one or more embodiments, the term “the negative electrode coating layer” refers to a layer that helps the movement of lithium ions released from the positive electrode active material to the negative electrode during charging and discharging of the all solid-state battery, thereby facilitating their deposition on the surface of the current collector. In an implementation, a lithium-containing layer, e.g., a lithium deposition layer, due to the deposition of lithium ions between the current collector and the negative electrode coating layer may be formed, and the lithium deposition layer acts as a negative electrode active material. This negative electrode generally refers as a deposition-type negative electrode. The carbon material and the metal included in the negative electrode coating layer may not act as a negative electrode active material which directly participates in the charge and discharge reaction. Such a deposition-type negative electrode represents a negative electrode that does not include a negative electrode active material during the battery preparation, but the lithium-included layer acts as a negative electrode active material.

The negative electrode coating layer may include a carbon material and a metal.

The carbon material and the metal may be presented by mixing together, or the metal may be presented by supporting it on the carbon material.

The carbonaceous material may be, e.g., crystalline carbon, amorphous carbon, or a combination thereof. In an implementation, the carbonaceous material may be amorphous carbon. The crystalline carbon may be, e.g., natural graphite, artificial graphite, mesophase carbon microbead, carbon nanotube, graphene, or a combination thereof. The crystalline carbon may have unspecified shape, sheet shape, flake shape, spherical shape, or fiber shape. The amorphous carbon may be, e.g., carbon black, acetylene black, denka black, ketjen black, furnace black, activated carbon, graphene, or combinations thereof. The carbon black may be Super P (available from Timcal, Ltd.). The amorphous carbon may be a suitable material which may be classified as amorphous carbon.

In an implementation, the carbon material may single particles, a secondary particle in which a plurality of primary particles is agglomerated, or combinations thereof. In an implementation, the carbon material may be in the form of single particles, and the carbon material may have an average particle diameter of about 100 nm or less, e.g., a nanosize of about 10 nm to about 100 nm.

In an implementation, the carbon material may be an agglomerated product, and the particle diameter of the primary particle may be about 20 nm to about 100 nm and the particle diameter of the secondary particle may be about 1 μm to about 20 μm.

In an implementation, a particle diameter of the primary particles may be about 20 nm to about 100 nm, about 20 nm to about 90 nm, about 20 nm to about 80 nm, or about 30 nm to about 70 nm.

In an implementation, a particle diameter of the secondary particle may be about 1 μm to about 20 μm, about 2 μm to about 15 μm, or about 3 μm to about 10 μm.

The shape of the primary particle may be spherical, oval, plate-shaped, or combinations thereof. In an implementation, the shape of the primary particle may be spherical, oval, or combinations thereof.

The metal may be Ag, Au, Sn, Zn, Al, Mg, Ge, Cu, In, Ni, Bi, Pt, Pd, or a combination thereof. In an implementation, it may be Ag. The inclusion of the metal in the negative electrode coating layer may help further improve the electrical conductivity of the negative electrode.

The metal may be nano particles and the size of the metal nano particles, e.g., an average size may be about 5 nm to about 800 nm, about 5 nm to about 700 nm, about 5 nm to about 500 nm, or about 5 nm to about 300 nm. In an implementation, if it has nanometers, it may be appropriately used. In an implementation, the metal nanoparticles with nano size may be used, and the battery characteristics, e.g., cycle-life characteristics of the all solid-state battery, may be improved. If the size of the metal particles were to increase to a micrometer unit, the uniformity of the metal particles could be reduced in the negative electrode coating layer, and thus, a current density could be increased at a specific region, thereby deteriorating the cycle-life characteristics.

In an implementation, an amount of the metal may be, based on the total weight of the negative electrode coating layer, about 14 wt % to about 35 wt %, about 18 wt % to about 25 wt %, or about 20 wt % to about 24 wt %.

The amount of the carbon material may be, based on the total weight of the negative electrode coating layer, about 55 wt % to about 80 wt %, about 60 wt % to about 75 wt %, or about 65 wt % to about 70 wt %.

The negative electrode coating layer may further include a binder. The binder may be a non-aqueous binder.

The aqueous binder may be, e.g., polyvinyl chloride, carboxylated polyvinyl chloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamide imide, polyimides, polyacrylate, or a combination thereof.

An amount of the binder may be about 1 wt % to about 15 wt %, based on the total weight of the negative electrode coating layer. In an implementation, an amount of the binder may be about 1 wt % to about 14 wt %, about 1 wt % to about 12 wt %, about 1 wt % to about 10 wt %, about 2 wt % to about 8, or about 2 wt % to about 7 wt %, based on the total weight of the negative electrode coating layer.

Maintaining the amount of the binder in the negative electrode coating layer of the all solid-state battery within the above weight ranges may help ensure that the electrical resistance and the adherence may be improved, thereby enhancing the characteristics of the all solid-state battery (battery capacity and power characteristics).

The negative electrode coating layer may further include a solid electrolyte. The solid electrolyte may be an inorganic solid electrolyte such as a sulfide solid electrolyte, an oxide solid electrolyte, a halide solid electrolyte, or the like, or solid polymer electrolyte.

The sulfide solid electrolyte may be as described in the solid electrolyte layer above. The sulfide solid electrolyte included in the negative electrode coating layer may be the same or different from the sulfide solid electrolyte included in the solid electrolyte layer.

The oxide solid electrolyte may be, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), Pb(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr, x is an integer of 1 to 10), or a mixture thereof.

The halide solid electrolyte may include a Li element, a M element (where M is a metal except for Li), and a X element (where X is a halogen). The X may be, e.g., F, Cl, Br and I. In an implementation, the halide solid electrolyte may include Br or Cl, as the X. The M may be, e.g., Sc, Y, B, Al, Ga, In, or the like.

In an implementation, the halide solid electrolyte may be represented by Li₆₋₃ₐMₐBr_{b}Cl_{c} (where, M is a metal, except for Li, 0<a<2, 0≤b≤6, 0≤c≤6, b+c=6). The a may be about 0.75 or more, or about 1 or more, and the a may be about 1.5 or less. The b may be about 1 or more, or about 2 or more. The c may be about 3 or more, or about 4 or more. In an implementation, the halide solid electrolyte may be, e.g., Li₃YBr₆, Li₃YCl₆ or Li₃YBr₂Cl₄.

The solid polymer electrolyte may include, e.g., polyethylene oxide, poly(diallyldimethyl ammonium)trifluoromethane sulfonylimide (TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ(PO₄)₃ (0.1≤x≤0.9), Li₁₊ₓHf₂₋ₓAlₓ(PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (where M is a rare earth elements such as Nd, Gd, Dy, or the like), Li₅ZrP₃O₁₂, Li₅TiP₃O₁₂, Li₃Fe₂P₃O₁₂, Li₄NbP₃O₁₂, Li₁₊ₓ(M,Al,Ga)ₓ (Ge_{1-y}Ti_{y})₂₋ₓ PO₄₃ (0≤x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, Q is Al or Ga), Li₆BaLa₂Ta₂O₁₂, Li₇La₃Zr₂O₁₂, Li₅La₃Nb₂O₁₂, Li₅La₃M₂O₁₂ (where M is Nb or Ta), or Li₇₊ₓAₓLa₃₋ₓZr₂O₁₂ (0<x<3 and A is Zn).

In an implementation, the negative electrode coating layer may further include the solid electrolyte, and the amount of the solid electrolyte may be suitably adjusted.

In an implementation, negative electrode coating layer may further include an additive, e.g., a filler, a dispersing agent, an ionic conductive material, or the like. As the filler, the dispersing agent, the ionic conductive material included in the negative coating layer, a suitable material generally used for the all solid-state battery may be used.

A thickness of the negative electrode coating layer may be about 1 μm to about 20 μm. In an implementation, the thickness of the negative electrode coating layer may be about 1 μm or more, about 3 μm or more, about 5 μm or more, and about 20 μm or less, about 18 μm or less, about 16 μm or less, about 14 μm or less, about 12 μm or less, or about 10 μm or less.

The current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the current collector may be about 1 μm to 20 μm, about 5 μm to about 15 μm, or about 7 μm to about 10 μm.

The negative current collector may include the metal as a substrate and may further include a thin film on the substrate. The thin film may include an element being capable of forming an alloy with lithium, e.g., gold, silver, zinc, tin, indium, silicon, aluminum, bismuth, or a combination thereof, or other material that can form an alloy with lithium. In an implementation, the current collector may further include a thin film, and the more flattened lithium-containing layer may be formed. In an implementation, the lithium may be deposited during charging to form the lithium-containing layer, thereby further improving the cycle-life characteristics of the all solid-state battery.

A thickness of the thin film be about 1 nm to about 800 nm, about 10 nm to about 700 nm, about 50 nm to about 600 nm, or about 100 nm to about 500 nm. Maintaining the thickness of the thin film within the ranges may help ensure that the cycle-life characteristics may be further enhanced.

The negative electrode according to one or more embodiments may further include a lithium-containing layer between the current collector and the negative electrode coating layer at the initial charge after the battery preparation. In an implementation, the thickness of the lithium-containing layer may be about 1 μm to about 1,000 μm, about 1 μm to about 500 μm, about 1 μm to about 200 μm, about 1 μm to about 150 μm, about 1 μm to about 100 μm, or about 1 μm to about 50 μm. Maintaining the thickness of the lithium-containing layer within the ranges may help ensure that it may effectively perform the role of a lithium reservoir and the cycle-life characteristics may be further enhanced.

The lithium-containing layer may be formed by releasing lithium ions from a positive electrode active material, passing through the solid electrolyte and moving move to the negative electrode, and it is precipitated and deposited on the negative current collector, after fabricating the battery.

The charging may be a formation process which may be performed at 0.05 C to 1 C at about 25° C. to about 50° C. once to three times. In an implementation, lithium may be precipitated and deposited to form the lithium-containing layer, lithium included in the lithium-containing layer is ionized during discharging to move to the positive direction, and this lithium may be used as a negative electrode active material.

In an implementation, the lithium-containing layer may be positioned between the current collector and the negative electrode coating layer, the negative electrode coating layer may serve as a protecting layer for the lithium-containing layer, and thus, the deposition growth of lithium dendrite may be suppressed. This may help inhibit capacity fading and short-circuit of the all solid-state battery and may resultantly improve the cycle-life of the all solid-state battery.

### <Elastic Layer>

The all solid-state battery according to one or more embodiments may further include an elastic layer which may help buffer changes in the thickness of the electrode during charging and discharging. The elastic layer may be between the negative electrode and a case.

The elastic layer may include materials having elasticity recovery rate of about 50% or more and insulating properties, e.g., may include a silicon rubber, an acryl rubber, a fluorine rubber, nylon, a synthetic rubber, or a combination thereof. The elastic layer may be a polymer sheet.

### <Preparation of all Solid-State Battery>

The all solid-state battery according to one or more embodiments may be fabricated by sequentially stacking the negative electrode, and the positive electrode, the solid electrolyte layer between the negative electrode and the positive electrode to prepare an assembly and pressurizing the assembly.

The pressurization may be carried out at a temperature of about 25° C. to about 90° C. The pressurization may be carried out under a pressure of about 550 MPa, e.g., about 500 MPa or less, or a pressure of about 1 MPa to about 500 MPa. The pressurization time may be varied depending on temperature and pressure, e.g., it may be less than about 30 minutes. The pressurization may be, e.g., isostatic press, roll press, plate press, or warm isostatic press.

The all-solid-state rechargeable battery may be a unit cell having a structure of positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state rechargeable battery may be, e.g., coin-shaped, button-shaped, sheet-shaped, stacked-shaped, cylindrical, flat, or the like. The all-solid-state rechargeable battery may also be applied to large batteries used in electric vehicles, or the like. In an implementation, the all-solid-state rechargeable battery may also be used in hybrid vehicles such as plug-in hybrid electric vehicles (PHEV). In an implementation, it may be used in a field requiring a large amount of power storage, and may be used, e.g., in an electric bicycle or a power tool. The all-solid-state rechargeable battery may be used in various fields such as portable electronic devices.

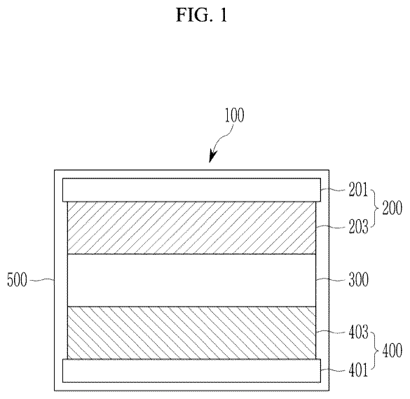

FIG. 1 is a cross-sectional view showing the all solid-state battery according to one or more embodiments. Referring to FIG. 1, the all solid-state battery 100 may have a structure in which electrode assembly includes a negative electrode 400 (including a negative electrode current collector 401 and a negative electrode layer 403), a solid electrolyte layer 300, a positive electrode 200 (including a positive electrode current collector 201 and a positive electrode active material layer 203), which may be housed on a case such as a pouch, or the like. The all solid-state battery 100 may further include an elastic layer 500 on the outside of at least one of the positive electrode 200 and the negative electrode 400.

In an implementation, the all-solid-state battery may be charged, and lithium ions may be released from the positive electrode active material and deposited on the negative electrode current collector 401, thereby preparing a lithium-containing layer (lithium deposition layer).

In an implementation, as illustrated in FIG. 1, one electrode assembly may include a negative electrode 400, a solid electrolyte layer 300, and a positive electrode 200, or an all solid-state battery may be fabricated by stacking at least two electrode assemblies. In an implementation, 2 to 100 electrode assemblies, 3 to 50, or 4 to 20, or the like may be stacked.

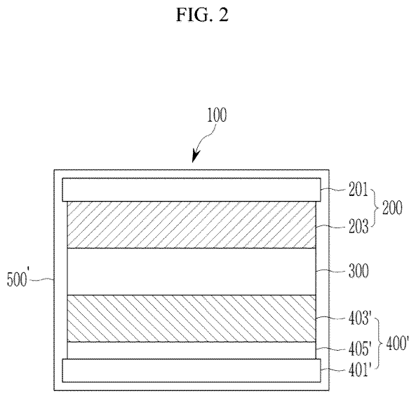

FIG. 2 schematically shows an all-solid-state battery according to some embodiments. The all-solid-state battery 100 shown in FIG. 2 may include a positive electrode 200 (including a positive electrode current collector 201 and a positive electrode active material layer 203), a negative electrode 400′ (including a negative electrode current collector 401′ and a negative electrode coating layer 403′), and a solid electrolyte layer 300 between the positive electrode 200 and the negative electrode 400′, and a battery case 500′ housing the same. The negative electrode 400′ may also include a lithium precipitation layer 405′ between the negative electrode current collector 401′ and the negative electrode coating layer 403′.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### 1) Preparation of Solid Electrolyte Layer

Li₂S and LiI were mixed at a weight ratio of 2:3 and the resulting mixture was ball-milled for 8 hours to prepare a solid solution with a particle diameter of 1 μm.

The solid solution and Li₆PS₅Cl (D50-3.5 μm) were mixed at a weight ratio of 9.8:88.2 to prepare a solid electrolyte.

2 wt % of an acryl rubber binder and 98 wt % of the solid electrolyte were added to an isobutyl isobutyrate solvent to prepare a solid polymer layer composition.

The solid electrolyte layer composition was coated on a polyethylene terephthalate release film using a blade coater, pre-dried at approximately 130° C., and then dried under a vacuum condition at approximately 80° C. to prepare a solid electrolyte layer with a thickness of approximately 100 μm to 150 μm.

### 2) Preparation of Negative Electrode

0.25 g of a mixture of carbon black with an average particle diameter (D50) of about 30 nm and silver (Ag) with an average particle diameter (D50) of about 60 nm at a weight ratio of 3:1, was added to 2 g of an N-methyl pyrrolidone solution including 7 wt % of a polyvinylidene fluoride binder, and mixed to prepare a negative electrode coating layer composition.

The negative electrode coating layer composition was coated on a nickel foil current collector using a bar coater and vacuum-dried to prepare a deposition-type negative electrode in which a negative electrode coating layer was formed on the current collector.

### 3) Preparation of Positive Electrode

85 wt % of a LiNi_{0.8}Co_{0.15}Mn_{0.05}O₂ coated with Li₂O—ZrO₂, positive electrode active material, 13.5 wt % of a solid electrolyte Li₆PS₅Cl, 1.0 wt % of a polyvinylidene fluoride binder 1.0 wt %, and 0.5 wt % of a carbon nanotube conductive material were mixed in an isobutyl isobutyrate solvent to prepare a positive electrode composition.

The positive electrode composition was coated on an Al foil positive current collector using a bar coater, dried, and pressed to prepare a positive electrode.

### 4) Fabrication of all Solid-Type Cell

The solid electrolyte layer was stacked on the negative electrode and then the positive electrode was stacked thereon to fabricate a unit cell. The resultant was inserted to a polyethylene terephthalate releasing film, a warm isostatic press (WIP) was subjected to thereto under 500 MPa at 80° C. for 30 minutes, and then the polyethylene terephthalate release film was removed, thereby fabricating an all solid-state secondary cell.

### Comparative Example 1

An all solid-state cell was fabricated by the same procedure as in Example 1, except that 2 wt % of an acryl rubber binder and 98 wt % of a Li₆PS₅Cl (D50=3.5 μm) solid electrolyte were added to an isobutyl isobutyrate solvent to prepare a solid polymer layer composition.

### Comparative Example 2

Solid sulfur and LiI were mixed at a weight ratio of 2:3 and the resulting mixture was ball-milled for 8 hours to prepare a solid solution with a particle diameter of 1 μm. An all solid-state rechargeable cell was fabricated by the same procedure as in Example 1, except that the solid solution was used.

### Evaluation 1) Evaluation of Cycle-Life

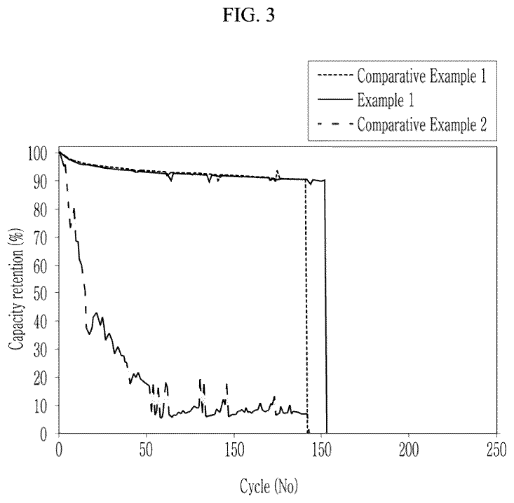

The all solid-state rechargeable cell of Example 1, and Comparative Examples 1 and 2 were subjected to a charge and a discharge cycle of 0.33 C charge and 0.33 C discharge. A ratio of discharge capacity at each cycle relative to a first discharge capacity were calculated. The results are shown as capacity retention in FIG. 3.

As shown in FIG. 3, Example 1 and Comparative Example 1 exhibited excellent capacity retention, and the short-circuit occurred for 152 cycles in Example 1, but the short-circuit occurred for 142 cycles in Comparative Example 1. Comparative Example 2 exhibited a slight short-circuit from the initial cycle, leading to a drastic decrease in capacity retention.

### Evaluation 2) Evaluation of Fast Charge

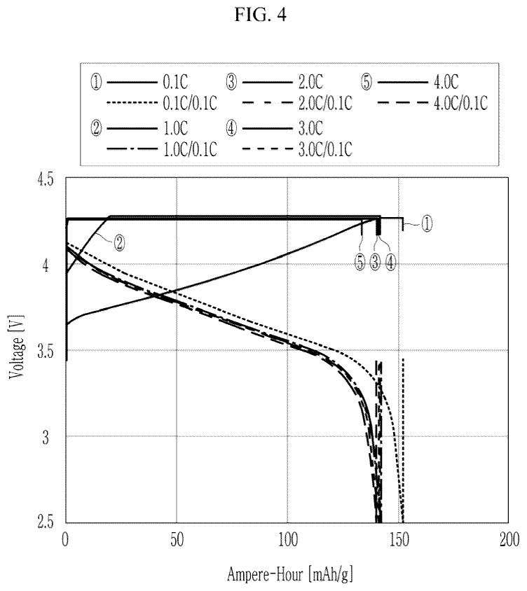

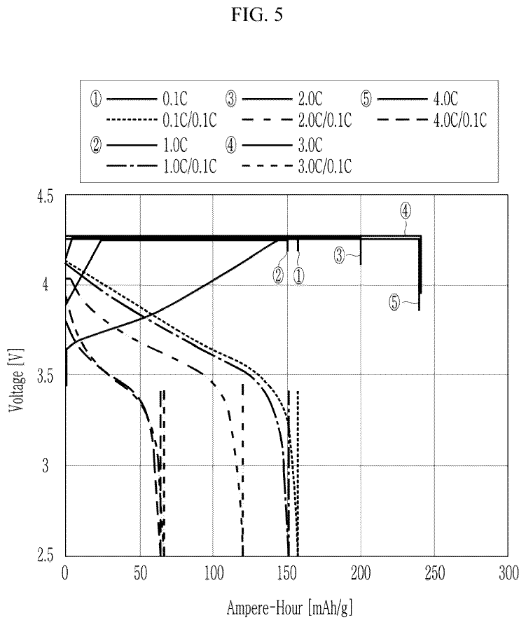

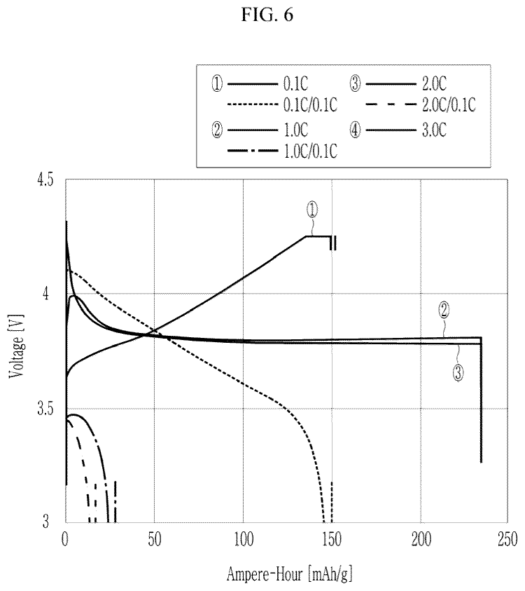

The all solid-state cells according to Example 1, and Comparative Examples 1 and 2 were once charged at 0.1 C and discharged at 0.1 C/once charged at 1.0 C and discharged at 0.1 C/once charged at 2.0 C and discharged at 0.1 C/once charged at 3.0 and discharged at 0.1 C/once charged at 4.0 C and discharged at 0.1 C. The result of Example 1 is shown in FIG. 4, the result of Comparative Example 1 is shown in FIG. 5, and the result of Comparative Example 2 is shown in FIG. 6.

As shown in FIG. 4, in case of charging the cell of Example 1 at 1.0 C to 4.0 C, overcharging did not occur, in case of charging it at 1.0 C to 3.0, each charge capacity was exhibited as 140 mAh/g, and in case of charging it at 4.0 C, charge capacity was exhibited as 133 mAh/g. When charging at 0.1 C, the charging amount was slightly reduced compared to the charging amount of 151 mAh/g. The discharge capacity of Example 1 was also identically about 139 mAh/g when charging at 1.0 C to 4.0 C, which is about 8% reduced compared to the discharge capacity of 151 mAh/g when charging and discharging at 0.1 C. This reduction rate may be interpreted as not having substantially decreased.

As shown in FIG. 5, the cell of Comparative Example 1 exhibited overcharge (200 mAh/g) when charged at 2.0 C, and the discharge capacity was about 120 mAh/g, which is a decrease of about 20% compared to the discharge capacity (151 mAh/g) when charged and discharged at 0.1 C. When charged at 3.0 C and 4.0 C charge, it exhibited overcharge (240 mAh/g) and the discharge capacity was about 64 mAh/g, which decreased at about 58% compared to the discharge capacity (151 mAh/g) when charged and discharged at 1 C.

As shown in FIG. 6, the cell of Comparative Example 2 exhibited overcharge (234 mAh/g) when charged at 1.0 C, and the discharge capacity was about 27 mAh/g, which is a decrease of about 82%, compared to the discharge capacity (151 mAh/g) when charged and discharged at 0.1 C. When charged at 2.0 C, overcharge (234 mAh/g) was exhibited, and the discharge capacity of approximately 16 mAh/g was decreased by 90%, compared to the discharge capacity (151 mAh/g), when charged and discharged at 0.1 C. It may be seen that when charged at 3.0 C, the cell was not be driven due to a large-area short circuit.

One or more embodiments may provide a solid electrolyte for an all solid-state battery exhibiting excellent durability.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid electrolyte for an all solid-state battery, the solid electrolyte comprising:
an argyrodite-type compound;
a sulfur-containing compound; and
an iodine-containing compound.

2. The solid electrolyte for an all solid-state battery as claimed in claim 1,
wherein the sulfur-containing compound comprises Li₂S.

3. The solid electrolyte for an all solid-state battery as claimed in claim 1,
wherein the iodine-containing compound comprises LiI.

4. The solid electrolyte for an all solid-state battery as claimed in claim 1,
wherein a mixing ratio of the sulfur-containing compound and the iodine-containing compound is about 1:9 to about 9:1 by weight.

5. The solid electrolyte for an all solid-state battery as claimed in claim 1,
wherein the sulfur-containing compound and the iodine-containing compound are a solid solution in the solid electrolyte.

6. The solid electrolyte for an all solid-state battery as claimed in claim 5, wherein the solid solution has a particle diameter of about 5 μm or less.

7. The solid electrolyte for an all solid-state battery as claimed in claim 5, wherein the solid solution has a particle diameter of about 0.1 μm to about 5 μm.

8. The solid electrolyte for an all solid-state battery as claimed in claim 5, wherein an amount of the solid solution is about 1 wt % to about 30 wt %, based on a total weight of the solid electrolyte.

9. The solid electrolyte for an all solid-state battery as claimed in claim 1, wherein an amount of the argyrodite-type compound is about 70 wt % to about 99 wt %, based on a total weight of the solid electrolyte.

10. The solid electrolyte for an all solid-state battery as claimed in claim 1, wherein the argyrodite-type compound comprises a sulfide compound.

11. The solid electrolyte for an all solid-state battery as claimed in claim 1, wherein the argyrodite-type compound comprises LiₐM_{b}P_{c}S_{d}Aₑ, in which a, b, c, d and e are all 0 or more and 12 or less, M is Ge, Sn, Si, or a combination thereof, and A is F, Cl, Br, or I.

12. The solid electrolyte for an all solid-state battery as claimed in claim 11, wherein the argyrodite-type compound comprises Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P (S_{4.70}SO_{40.05}) Cl_{1.25}, (Li_{5.69}Cu_{0.06})P (S_{4.60} SO_{40.15})Cl_{1.25}, (Li_{5.72}Cu_{0.03})P (S_{4.725} SO_{40.025})Cl_{1.25}, (Li_{5.72}Na_{0.03})P (S_{4.725} SO_{40.025}) Cl_{1.25}, Li_{5.75}P (S_{4.725} SO_{40.025}) Cl_{1.25}, or a combination thereof.

13. An all solid-state battery, comprising:
a negative electrode;
a positive electrode; and
a solid electrolyte layer between the positive electrode and the negative electrode, the solid electrolyte layer comprising the solid electrolyte of claim 1.

14. The all solid-state battery as claimed in claim 13, wherein the solid electrolyte layer further comprises a binder.

15. The all solid-state battery as claimed in claim 13, wherein the negative electrode comprises a metal and a carbon material.

16. The all solid-state battery as claimed in claim 15, wherein the metal comprises Ag, Zn, Al, Sn, Mg, Ge, Cu, In, Ni, Bi, Au, Si, Pt, Pd, or a combination thereof.

17. The all solid-state battery as claimed in claim 15, wherein the carbon material comprises crystalline carbon, amorphous carbon, or a combination thereof.
